(19) United States
(12) Patent Application Publication
(10) Pub. No.: US 2014/0108059 A1
(43) Pub. Date: Apr. 17, 2014

(54) SYSTEMS AND METHODS FOR UTILIZING AN ECONOMIC MODEL THAT INCORPORATES ECONOMIC INFLUENCES TO PREDICT TRANSACTIONS

(71) Applicant: United Services Automobile Association, San Antonio, TX (US)

(72) Inventors: Marvin L Ring, San Antonio, TX (US); Jason D. Maupin, San Antonio, TX (US); Allison Gonzalez, San Antonio, TX (US); Mark Damron, San Antonio, TX (US)

(73) Assignee: UNITED SERVICES AUTOMOBILE ASSOCIATION, San Antonio, TX (US)

(21) Appl. No.: 14/053,818

(22) Filed: Oct. 15, 2013

Related U.S. Application Data
(60) Provisional application No. 61/714,092, filed on Oct. 15, 2012.

(51) Int. Cl. G06Q 40/08

(52) U.S. Cl. CPC G06Q 40/08
USPC 705/4

(57) ABSTRACT

Systems and methods for utilizing models that incorporate economic influences to predict transactions and/or events. In one embodiment, a method is described that generates a predictive model that may incorporate economic influences, such as weekdays in a month, lagging economic indicators such as unemployment data, leading economic indicators such as an industrial index, energy costs such as the price of gas, and real-world events such as precipitation, and utilizing the predictive model to predict events such as car insurance claims.

### CROSS REFERENCE TO RELATED APPLICATIONS

This application claims priority to U.S. Application Ser. No. 61/714,092, filed Oct. 15, 2012, which is incorporated herein by reference in its entirety.

### FIELD OF THE INVENTION

The present invention relates to modeling future business events, and more particularly, to utilizing economic influences while modeling financial results.

### BACKGROUND OF THE INVENTION

The ability to effectively predict future business events and utilize those predictions to inform business decisions remains an unachieved goal. For example, an insurance company may wish to model the number of insurance claims over the next several months. However, the current methodology is inaccurate at making such predictions and, in some cases, may be too reliant on past performance to predict future events, which may disguise a paradigm shift of the business model.

Accordingly, there is an unmet need to provide companies, such as insurance companies, the ability to more accurately model future events such as claim applications.

### SUMMARY OF THE INVENTION

The purpose and advantages of the below described illustrated embodiments will be set forth in and apparent from the description that follows. Additional advantages of the illustrated embodiments will be realized and attained by the devices, systems, and methods particularly pointed out in the written description and the claims herein, as well as from the drawings.

To achieve these and other advantages and in accordance with the purpose of the illustrated embodiments, described herein are systems and methods for modeling future events based on a combination of time series modeling and economic data input that includes a management system preferably running on a server. The management system acquires data, such as economic data based on economic factors, to be incorporated into model generation. A modeling engine in the system selects a time series analysis model to be utilized, and the time series model and the economic data are communicated to a calculation engine. The new predictive model is generated and communicated to user(s) and/or other computing devices. The predictive model may be optionally compared to legacy data to determine an accuracy of the predictive model.

### BRIEF DESCRIPTION OF THE DRAWINGS

So that those having ordinary skill in the art, to which the present embodiments pertain, will more readily understand how to employ the novel system and methods, certain illustrated embodiments thereof will be described in detail herein-below with reference to the drawings, wherein:

FIG. 1 illustrates a system diagram of an exemplary embodiment of a management system for generating a predictive model;

FIG. 2 illustrates an exemplary graph of actual data as compared to two models' predictions;

FIG. 3 is a flow chart illustrating an exemplary use of the embodiment of FIG. 1; and

FIG. 4 is an illustration of an embodiment of a computing device.

### DETAILED DESCRIPTION OF CERTAIN EMBODIMENTS

The below illustrated embodiments are directed to management system and method for generating a predictive model for future events by optionally combining selected economic data and input with a time series model. It is to be appreciated the below illustrated embodiments are not limited in any way to what is shown, as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the certain illustrated embodiments. Also, the flow charts described herein do not imply a required order to the steps, and the illustrated embodiments and processes may be implemented in any order that is practicable.

Unless defined otherwise, all technical and scientific terms used herein have the same meaning as commonly understood by one of ordinary skill in the art relating to the below illustrated embodiments. Although any methods and materials similar or equivalent to those described herein can also be used in the practice or testing of the below illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the certain embodiments described herein may be utilized in conjunction with a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be executed by a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the certain embodiments described herein. Thus the certain embodiments are not to be understood to be limited by what has been particularly shown and described, except as indicated by the appended claims.

The methods described herein allow users to, in an exemplary use, generate a predictive model based on selected economic data to be incorporated into a model, such as a time series model. A user interacts with a management system operating on one or more servers, the user either interacting directly with the management system, or via a client computing device.

In one embodiment directed towards predicting future car insurance claims by car insurance policy members, the user selects a time series analysis model to predict future claims. The user then selects one or more elements of economic data to be incorporated into the model. In one embodiment, the user selects two elements of economic data: an industrial index and the number of workdays in a month. These two elements are incorporated into the selected model and a new predictive model is generated. The predictive model then provides monthly predictions about the number of car insurance claims that will be made by the insurance company's members.

In an exemplary use, a retrieval engine receives data to be incorporated into generation of a new predictive model and a modeling engine selects a model to be utilized, such as a time series analysis model. The data and the model are communicated to a calculation engine that utilizes the data and the model to calculate a new predictive model and communicate the new predictive model to the modeling engine. The modeling engine communicates the new predictive model to a user, and optionally also communicates the new predictive model to a comparison engine. The comparison engine may access legacy data to compare the ability of the predictive model to retroactively predict “future” events that have already occurred. The comparison engine then optionally calculates a determination of the accuracy of the predictive model.

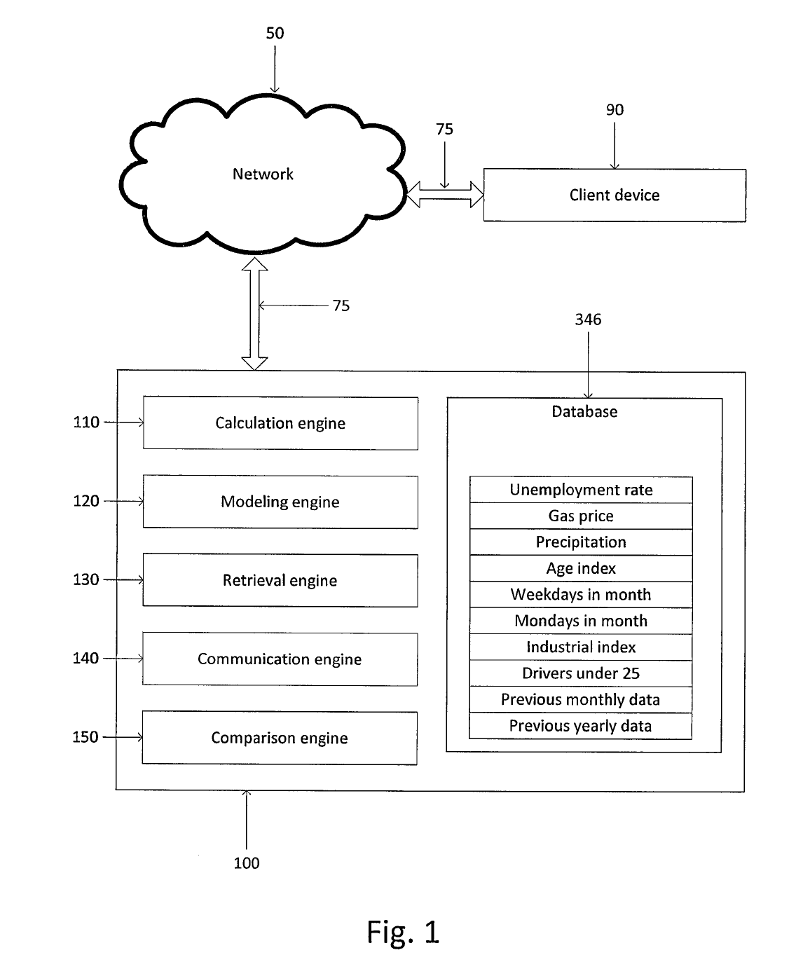

Referring to FIG. 1, a hardware diagram depicting a management system 100 in which the processes described herein can be executed is provided for exemplary purposes. In one embodiment, system 100 includes network 50, communications 75, calculation engine 110, modeling engine 120, retrieval engine 130, communication engine 140, and comparison engine 150. System 100 further includes database 346 that includes economic data such as an unemployment rate, gas prices, precipitation, an age index, days in selected months, Mondays in selected months, an industrial index, a number of drivers under 25, previously monthly data, and previous yearly data.

For exemplary purposes only, the economic data may be comprised as follows. The unemployment rate may reflect the unemployment rate of only the policy members that are insured by an insurance company utilizing system 100, and/or it may reflect the unemployment rate of the country. Employment related data may comprise the “Civilian Unemployment Rate” as measured, calculated and promulgated by the U.S. Department of Labor: Bureau of Labor Statistics. In one embodiment, other “lagging” economic measures may be utilized.

The gas price may be the average price across the country, or it may be weighted for certain areas within which a higher percentage of policy members reside. The gas price, or energy prices/costs, may be limited to gas prices for automobiles, or it may include any information, including prices, related to energy generation, consumption and/or purchase. In one embodiment, an index for energy prices may be utilized.

The precipitation data may be an average for the country, it may be a weighted average based on the population density within each precipitation projection and/or measurement, and it may be a weighted average based on the policy member population density within each precipitation projection and/or measurement. The age index may be an average of policy members, an average of a relevant population (e.g., country, state(s), counties), wherein the average may be a mean, median, mode, or a combination thereof. In one embodiment, the age index may be reflective of the amount and/or percentage of policy members that are under or over the age of 25.

The days in selected months may include all working days in the months, it may include all working days plus any holidays that are not contiguous with a weekend, and it may include all weekdays. The Mondays in selected months may include all non-holiday Mondays, and it may include all Mondays, holiday or not. In one embodiment, the days counted in a selected month (or any time period) may include holidays, such as Federal Holidays, that are located in neither the first or the last week of the month (or time period).

The industrial index may include U.S. industrial/manufacturing output, leading economic indicators of U.S. Gross Domestic Product, measures of economic health, or any other information related to production, manufacturing, other “leading” economic indicators, and/or combinations thereof.

The number of drivers may include all policy members under the age of 25, and it may include all population members under the age of 25 with driver's licenses. Previous monthly data and previously yearly data may include legacy data for previous months and years that includes the number of claims, the number of policy members, when the claims occurred, previous data for the other economic data described herein, and/or previous data for any data, economic or otherwise.

Information related to purchases, such as vehicle purchases, may be utilized. In one embodiment, the “Light Weight Vehicle Sales: Autos & Light Trucks” report from the U.S. Department of Commerce: Bureau of Economic Analysis is utilized. However, it is contemplated herein that any information, such as purchasing information, may be used, such as, for exemplary purposes only and without limitation, only car purchases, all truck purchases, only light truck purchases, all personal vehicle purchases, all vehicle purchases (including commercial trucks), and/or any combination thereof.

In one embodiment, lending information, such as loan interest rates, may be utilized. Lending information may include, for exemplary purposes only and without limitation, a 30-year Fixed Rate Mortgage Average in the U.S.

Data described herein may be weighted in any of several ways. For exemplary purposes, one method of weighting the precipitation data includes calculating the percentage of policy members in given areas and weighting the precipitation data according to the percentage of policy members that may presumably be in those areas. For example, if the entire country has 20% of the area covered by precipitation that is predicted and/or measured, but 50% of policy members are located in areas covered by precipitation that is predicted and/or measured, then the precipitation data may be weighted to account for the disproportionate amount of policy members located in areas of expected/measured precipitation. Further, it is contemplated herein that any of the data described herein may be weighted as was just described, or in any way as known or used by those skilled in the art.

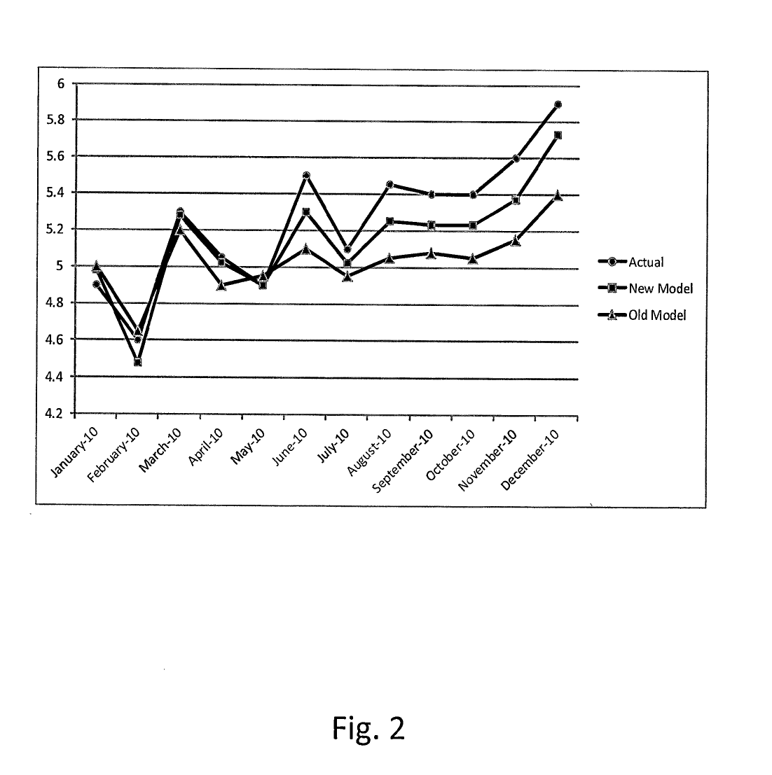

FIG. 2 illustrates an exemplary graph of actual data, predictions based on a model that does not incorporate the methods and system disclosed herein (“Old Model”), and predictions based on a model that incorporates the methods and system disclosed herein (“New Model”). As FIG. 2 demonstrates, models that fail to incorporate the systems and methods described herein may have some accuracy in the shorter term, but the accuracy of the older models becomes progressively worse until the model is quickly unusable. The New Model, however, and the systems and methods described herein, provides accuracy in both the short term as well as the long term. Thus, it will be recognized and it is contemplated herein that the systems and methods disclosed herein may be utilized for short term predictions such as the immediate month, the next month, and/or the following month, and may also be utilized for longer term predictions such as the rest of the year, the next year, the following year, and/or any time period as may be contemplated. Accordingly, this disclosure may be utilized to predict long-term macro trends (e.g., over years and/or decades) as well as shorter term specific predictions.

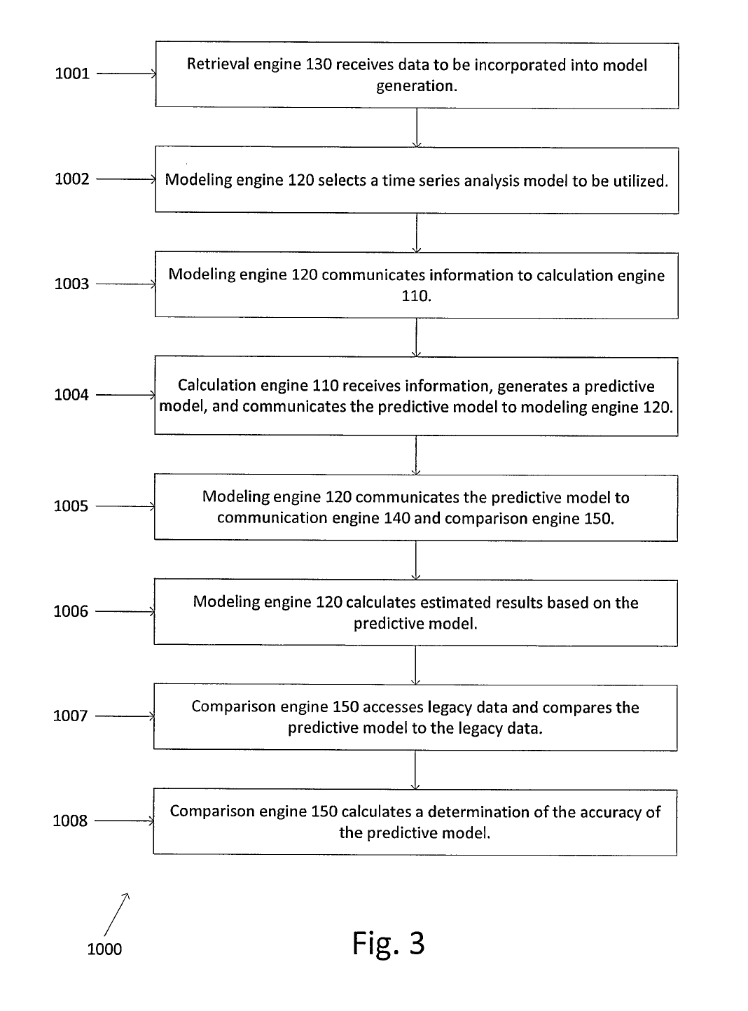

Turning to FIG. 3, illustrated therein is in an exemplary process 1000 of utilizing system 100. Starting at step 1001, retrieval engine 130 receives data to be incorporated into predictive model generation. The data may be, for exemplary purpose, received via input from a user utilizing a client computing device connected to management system 100 over network 50, data may be retrieved from database 346, or a combination thereof. The data may be based on factors, such as selected economic factors. Modeling engine 120 then combines data and selects a model, such as a time series analysis model, to be utilized (step 1002). Modeling engine 120 communicates information to calculation engine, information preferably including at least the data and the model selected (step 1003). Calculation engine 110 receives information, calculates a predictive model based on the selected data and selected model, and communicates the predictive model to modeling engine 120 (step 1004). Modeling engine 120 finalizes the model, including calculating output data for selected months/years, such as future months, and communicates the predictive model to communication engine 140 and optionally also communicates the new predictive model to comparison engine 150 (step 1005). Subsequently, modeling engine 120 generates estimated results based on the predictive model (step 1006).

In one embodiment, comparison engine 150 accesses legacy data, compares the new predictive model to the legacy data (step 1007), and optionally calculates a determination of accuracy of the predictive model (step 1008). Such a determination of accuracy may include providing legacy data to the predictive model and generating prediction data points, and comparing those prediction data points to measured data. For exemplary purposes, the predictive model could be provided data from two years ago and asked to “predict” the data for one year ago—the results of these “predictions” could be compared to the actual legacy data from one year ago, and from this comparison a determination of the accuracy of the model may be generated.

In an exemplary use of an embodiment, a car insurance company may generate and utilize a predictive model to estimate insurance claims with the predictive model being based on a time series model incorporating selected data points including lagging indicators such as (un)employment data, leading indicators such as data relating to the industrial field, the price of energy such as gas prices, precipitation, and working days in a selected time period.

In another exemplary use of an embodiment, a car insurance company may generate and utilize predictive models to estimate a number of vehicles being added or deleted from existing car insurance policies, with the predictive models being based on a time series model incorporating selected data points including the price of energy such as gas, a number of vehicles (such as cars and light trucks) being purchased generally, lending information such as the average interest rate for a 30-year fixed mortgage in the U.S., a ratio of vehicles in inventory (by dealers and/or manufacturers) as compared to the amount being sold, and/or the calendar months January, March and May. The predictive models may further incorporate information such as if there are 21 days in the target prediction month, and if such is the case that fact being negatively correlated with the addition or deletion of cars. The predictive models may further incorporate other calendar variables, such as certain months may be positively correlated with the addition and/or deletion of vehicles from car insurance policies. In one embodiment, the predictive model predicts a net amount of vehicles on an insurance company's car insurance policies (as in, the amount added minus the amount deleted to obtain the net amount of vehicles added or deleted).

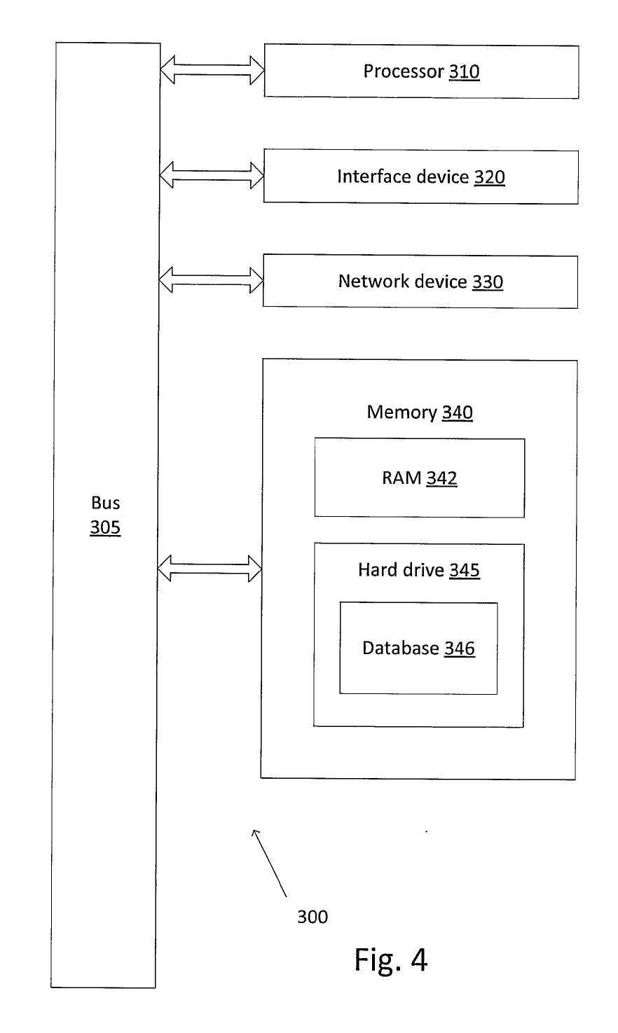

Turning now to FIG. 4, illustrated therein is an exemplary embodiment of computing device 300 that preferably includes bus 305, over which intra-device communications preferably travel, processor 310, interface device 320, network device 330, and memory 340, which preferably includes RAM 342 and hard drive 345, which may include database 346.

The term “module”/“engine” is used herein to denote a functional operation that may be embodied either as a stand-alone component or as an integrated configuration of a plurality of subordinate components. Thus, management module 100, calculation engine 110, modeling engine 120, retrieval engine 130, communication engine 140 and comparison engine 150 may be implemented as a single module or as a plurality of modules that operate in cooperation with one another. Moreover, although management module 100, calculation engine 110, modeling engine 120, retrieval engine 130, communication engine 140 and comparison engine 150 are described herein as being implemented as software, they could be implemented in any of hardware (e.g. electronic circuitry), firmware, software, or a combination thereof.

Memory 340 is a computer-readable medium encoded with a computer program. Memory 340 stores data and instructions that are readable and executable by processor 310 for controlling the operation of processor 310. Memory 340 may be implemented in random access memory 342 (RAM), a non-transitory computer readable medium, volatile or non-volatile memory, solid state storage devices, magnetic devices, hard drive 345, a read only memory (ROM), or a combination thereof.

Processor 310 is an electronic device configured of logic circuitry that responds to and executes instructions. Processor 310 outputs results of an execution of the methods described herein. Alternatively, processor 310 could direct the output to a remote device (not shown) via network 50.

It is to be further appreciated that network 50 depicted in FIG. 1 can include a local area network (LAN) and a wide area network (WAN), other networks such as a personal area network (PAN), or any combination thereof. Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. It is to be appreciated that the illustrated network connections of FIG. 1 are exemplary and other means of establishing a communications link between multiple computers may be used.

It should be understood that computing devices 300 each generally include at least one processor, at least one interface, and at least one memory device coupled via buses. Computing devices 300 may be capable of being coupled together, coupled to peripheral devices, and input/output devices. Computing devices 300 are represented in the drawings as standalone devices, but are not limited to such. Each can be coupled to other devices in a distributed processing environment.

It will be recognized by those skilled in the art that items that are positively correlated generally, although not necessarily, both increase or both decrease at the same time. For example, a sunny day is positively correlated with relatively warmer weather, but just because a day is sunny does not necessarily mean that a specific day will be relatively warmer (or vice versa). Further, and as will also be recognized by those skilled in the art, if item 1 and item 2 are negatively correlated, then generally, although not necessarily, if a measure of item 1 increases then a measure of item 2 will decrease in coordination therewith (or vice versa). Continuing with the weather example, a sunny day is negatively correlated with relatively colder weather.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A computer implemented method, utilizing at least one processor and memory, for generating and utilizing a predictive model, the method comprising:
selecting a time series analysis model to be utilized to generate the predictive model;
selecting a first economic factor and a second economic factor to be incorporated into the predictive model;
generating, using the at least one processor, the predictive model based on the time series analysis model, a first data point representing the first economic factor and a second data point representing the second economic factor.

2. The computer implemented method of claim 1, wherein the first economic factor is related to a number of workdays in a time period, and wherein the second economic factor is related to an industrial index, and wherein the predictive model relates to providing an estimate for an amount of vehicle insurance claims that will be asserted based on a plurality of vehicle insurance policies, the method further comprising:
calculating an estimated amount of vehicle insurance claims that will be asserted, in the time period, from a plurality of vehicle insurance policies that have been issued by an insurance company.

3. The computer implemented method of claim 2, wherein the time period is a month, the method further comprising:
selecting a month and a year, wherein the step of calculating the estimated amount of vehicle insurance claims comprises calculating the estimated amount for the selected month and year.

4. The computer implemented method of claim 3, wherein the first data point representing the first economic factor comprises the number of weekdays in the selected month and year that are not Federal Holidays.

5. The computer implemented method of claim 3, wherein the first data point representing the first economic factor comprises the number of weekdays in the selected month and year that are not Federal Holidays, with the exception that Federal Holidays are not excluded from the count if they are outside of both the first week and the last week of the selected month and year.

6. The computer implemented method of claim 2 further comprising
selecting a third economic factor to be incorporated into the predictive model, wherein the third economic factor is selected from the group of: a factor that relates to a lagging economic indicator, a factor that relates to energy prices, and a factor that relates to precipitation, and wherein the predictive model is further based on a third data point representing the third economic factor.

7. The computer implemented method of claim 6, wherein, when the third factor relates to energy prices, the step of generating the predictive model comprises negatively correlating the third data point with the estimated amount of vehicle insurance claims that will be asserted.

8. The computer implemented method of claim 2, further comprising:
selecting a third economic factor to be incorporated into the predictive model, wherein the third economic factor is selected from the group of: a factor that relates to an unemployment rate, a factor that relates to gas prices, and a factor that relates to precipitation, and wherein the predictive model is further based on a third data point representing the third economic factor.

9. The computer implemented method of claim 2, wherein the step of generating the predictive model comprises positively correlating the first data point and the second data point with the estimated amount of vehicle insurance claims that will be asserted.

10. The computer implemented method of claim 1, wherein the predictive model relates to estimating a net amount of vehicles that will be added to a plurality of vehicle insurance policies, the method further comprising:
calculating, via the modeling engine, an estimated amount of vehicles that will be added, in a time period, to a plurality of insurance policies.

11. The computer implemented method of claim 10, wherein the first economic factor is related to energy prices, and wherein the second economic factor is related to a ratio of vehicles in inventory as compared to an amount of vehicles sold, the method further comprising:
selecting a third economic factor that is an amount of cars and light trucks sold, wherein the predictive model is further based on a third data point representing the third economic factor.

12. The computer implemented method of claim 11, wherein the first economic factor relating to energy prices comprises a factor related to a price of gas.

13. A non-transitory computer readable storage medium and a computer program embedded therein, the computer program comprising a processor and instructions, which when executed by the processor cause the computer system to:
select a time series analysis model to be utilized to generate a predictive model, wherein the predictive model relates to providing an estimate for an amount of vehicle insurance claims that will be asserted from a plurality of vehicle insurance policies;
select a first economic factor and a second economic factor to be incorporated into the predictive model, wherein the first economic factor is related to a number of workdays in a time period, and wherein the second economic factor is related to a leading economic indicator;
generate the predictive model based on the time series analysis model and a first data point representing the first economic factor and a second data point representing the second economic factor.

14. The non-transitory computer readable storage medium of claim 13, the instructions further causing the computer system to:
calculate an estimated amount of vehicle insurance claims for a month and year.

15. The non-transitory computer readable storage medium of claim 14, wherein the first data point representing the first economic factor comprises the number of weekdays in the selected month and year that are not Federal Holidays, with the exception that Federal Holidays are not excluded from the count if they are outside of both the first week and the last week of the selected month and year.

16. The non-transitory computer readable storage medium of claim 15, the instructions further causing the computer system to:
select a third economic factor to be incorporated into the predictive model, wherein the third economic factor is selected from the group of: a factor that relates to a lagging economic indicator, a factor that relates to energy prices, and a factor that relates to precipitation, and wherein the predictive model is further based on a third data point representing the third economic factor.

17. The non-transitory computer readable storage medium of claim 14, the instructions further causing the computer system to:
select a third economic factor to be incorporated into the predictive model, wherein the third economic factor is related to a lagging economic indicator;
select a fourth economic factor to be incorporated into the predictive model, wherein the fourth economic factor is related to energy prices;
select a fifth economic factor to be incorporated into the predictive model, wherein the fifth economic factor is related to precipitation, wherein the predictive model is further based on a third data point representing the third economic factor, a fourth data point representing the fourth economic factor, and a fifth data point representing the fifth economic factor.

18. The non-transitory computer readable storage medium of claim 17, wherein the predictive model is negatively correlated with the fourth data point, and wherein the predictive model is positively correlated with the first, second, third and fifth data points.

19. A computer implemented method for generating and utilizing a predictive model, the method comprising:
selecting, via a management system's modeling engine, a time series analysis model to be utilized to generate a predictive model, the management system comprising the modeling engine, memory and a processor, wherein the predictive model relates to providing an estimate for an amount of vehicle insurance claims that will be asserted based on a plurality of vehicle insurance policies;
selecting, via the modeling engine, a first economic factor to be incorporated into the predictive model, wherein the first economic factor is related to a number of workdays in a time period;
accessing, via a retrieval engine, a first data point that represents the first economic factor, the management system further comprising the retrieval engine;
communicating the time series analysis model and the data point to a calculation engine, the management system further comprising the calculation engine;
generating, via the processor, the predictive model based on the time series analysis model and the data point;
communicating the predictive model to the modeling engine; and
calculating, by the modeling engine utilizing the processor, an estimated amount of vehicle insurance claims that will be asserted, in the time period, from a plurality of vehicle insurance policies that have been issued by an insurance company.

20. The computer implemented method of claim 19, wherein the factors further include a second economic factor that relates to energy prices and a third economic factor that relates to precipitation, the method further comprising:
accessing, via the retrieval engine, a second data point that represents the second economic factor, wherein the second data point is also communicated to the calculation engine; and
accessing, via the retrieval engine, a third data point that represents the third economic factor, wherein the third data point is also communicated to the calculation engine, wherein the step of generating the predictive model comprises generating the predictive model based on the time series analysis model and the three data points.
